(19) United States
(12) Patent Application Publication
(10) Pub. No.: US 2026/0225105 A1
(43) Pub. Date: Aug. 6, 2026

(54) A DYNAMIC PLATE SUPPORT STAGE DEVICE AND METHODS OF USE

(71) Applicant: ST. JUDE CHILDREN'S RESEARCH HOSPITAL, Memphis, TN (US)

(72) Inventors: Duane Currier, Memphis, TN (US); Taosheng Chen, Memphis, TN (US)

(21) Appl. No.: 19/148,200

(22) PCT Filed: Jan. 9, 2024
(86) PCT No.: PCT/US2024/010823

§ 371 Date: Jul. 15, 2025

Related U.S. Application Data
(60) Provisional application No. 63/439,705, filed on Jan. 18, 2023.

(51) Int. Cl. B01L 9/00

(52) U.S. Cl. CPC B01L 9/523; B01L 2200/023; B01L 2300/0829

(57) ABSTRACT

The present invention is related to the field of high-throughput laboratory automation and instrumentation. In particular, a dynamic plate support stage device is disclosed which makes any multi-well plate compatible with any commercially available instrument that acts on plates by generating downward vertical force by compensating for plate skirt height variations. For example, when applied in the context of a plate sealer stage, the dynamic support stage device comprises a rectangular upper frame supported by a compressible attachment and surrounds a plate-support block upon which a plate is secured. When in use, a sealer instrument applies downward force on the plate, which depresses the rectangular upper frame around the plate/plate-support block complex until the well bottom fully contacts the plate-support block thereby compensating for any plate skirt height variation.

### FIELD OF THE INVENTION

The present invention is related to the field of high-throughput laboratory automation and instrumentation. In particular, a dynamic plate support stage device is disclosed which makes any multi-well plate compatible with any commercially available instrument that acts on plates by generating downward vertical force by compensating for plate skirt height variations. For example, when applied in the context of a plate sealer stage, the dynamic support stage device comprises a rectangular upper frame supported by a compressible attachment and surrounds a plate-support block upon which a plate is secured. When in use, a sealer instrument applies downward force on the plate, which depresses the rectangular upper frame around the plate/plate-support block complex until the well bottom fully contacts the plate-support block thereby compensating for any plate skirt height variation. Upon completion of the sealing cycle, the upper frame returns to the upper at rest position providing a universal point in space where all plates start and end the cycle.

### BACKGROUND

Correctly sealing a diversity of multi-well plates in a seamless, integrated, and high throughput manner remains a challenge for high quality and efficient productivity. Although those in the art have standardized microplates in terms of width and length, the skirt height of different plate types can vary substantially. This variation of plate skirt height presents a challenge to the industry's standard laboratory automated plate sealers and is known to result in improper sealing due to the way the plate bottom is supported with commercially available sealer instruments. Skirt height can also influence the vertical positioning of plates on the stage which affects the reliability of robot movements when delivering and picking plates from the stage.

What is needed in the art is a device, and method, that provides a constant location for plates to be placed and delivered to various sealer instruments that compensates for these variations in skirt height. The presently disclose universal plate stage device solves this problem, thereby increasing high-throughput productivity and reliability while maintaining high quality plate seals.

### SUMMARY OF THE INVENTION

The present invention is related to the field of high-throughput laboratory automation and instrumentation. In particular, a dynamic plate support stage device is disclosed which makes any multi-well plate compatible with any commercially available instrument that acts on plates by generating downward vertical force by compensating for plate skirt height variations. For example, when applied in the context of a plate sealer stage, the dynamic support stage device comprises a rectangular upper frame supported by a compressible attachment and surrounds a plate-support block upon which a plate is secured. When in use, a sealer instrument applies downward force on the plate, which depresses the rectangular upper frame around the plate/plate-support block complex until the well bottom fully contacts the plate-support block thereby compensating for any plate skirt height variation. Upon completion of the sealing cycle, the upper frame returns to the upper at rest position providing a universal point in space where all plates start and end the cycle.

In one embodiment, the present invention contemplates a dynamic plate support device, comprising: a) a rectangular frame platform comprising a length and a width, said rectangular frame platform defined by: i) a first member comprising a first top surface and a first inner surface, wherein said first top surface is shorter than said length and longer than said width; ii) a second member comprising a second top surface and a second inner surface, wherein said second top surface is shorter than said length and longer than said width; and iii) a third member comprising a third top surface and a third inner surface, wherein said third top surface is shorter than said width; and iv) a fourth member comprising a fourth top surface and a fourth inner surface, wherein said fourth top surface is shorter than said width; b) a base support platform comprising said length and said width, wherein said base support platform comprises at least one compressible attachment that interfaces with a bottom surface of said rectangular frame platform; and c) a plate-support block attached to a top surface of said base support platform that is positioned below, and aligned within, said first inner surface, said second inner surface, said third inner surface and said fourth inner surface. In one embodiment, the rectangular frame platform further comprises at least one restraint flange. In one embodiment, the device further comprises at least one support post attached to said rectangular frame platform and slidably engaged with said base support platform. In one embodiment, the at least one compressible attachment comprises a spring. In one embodiment, the at least one compressible attachment comprises a piston. In one embodiment, the at least one compressible attachment comprises a hydraulic chamber. In one embodiment, the at least one compressible attachment comprises a compressed gas chamber. In one embodiment, the device further comprises a plate secured by said at least one restraint flange. In one embodiment, the plate further comprises a skirt having an open cavity. In one embodiment, the plate is a microplate. In one embodiment, the microplate comprises an array of microwells. In one embodiment, the skirt comprises a skirt height ranging between 0-8 millimeters. In one embodiment, the first inner edge, said second inner edge, said third inner edge and said fourth inner edge define an internal opening within said rectangular frame platform.

In one embodiment, the present invention contemplates a method, comprising: a) providing; i) a dynamic plate support stage comprising a plate-support block surrounded by a rectangular frame; ii) a plate comprising a skirt with an open cavity and an assay compartment bottom surface; and iii) a plate sealer instrument; b) securing the plate within the rectangular frame; and c) inserting the plate-support block into the skirt open cavity. In one embodiment, the inserting further comprises fully contacting the plate-support block with the assay compartment bottom surface. In one embodiment, the inserting further comprises depressing the rectangular frame with the plate sealer instrument. In one embodiment, the plate sealer instrument comprises a sealer unit. In one embodiment, the method further comprises sealing the top of the plate with the sealer unit. In one embodiment, the rectangular frame platform comprises an internal opening defined by a first inner edge, a second inner edge, a third inner edge and a fourth inner edge. In one embodiment, the depressing further comprises lowering the internal opening around the plate block. In one embodiment, the adjustable plate support stage further comprises a plurality of posts attached to said rectangular frame platform and are slidably engaged with said base support platform. In one embodiment, the adjustable plate support stage further comprises at least one compressible attachment that interfaces with the base support platform and the bottom surface of the rectangular frame. In one embodiment, at least one compressible attachment includes, but is not limited to, a spring, a piston, a hydraulic chamber and/or a compressed gas chamber. In one embodiment, the securing further comprises at least one restraint flange attached to the rectangular frame.

### Definitions

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity but also plural entities and also includes the general class of which a specific example may be used for illustration. The terminology herein is used to describe specific embodiments of the invention, but their usage does not delimit the invention, except as outlined in the claims.

The term “about” or “approximately” as used herein, in the context of any assay measurements refers to +/−5% of a given measurement.

The term “dynamic” as used herein, refers to a device that has moving parts.

The term “frame platform” refers to a structural piece of a device having a closed geometric shape composed of a series of solid perimeter members that are contiguously attached that circumscribe an internal defined open space. In particular, the width of each member is less that either the length or width of the closed geometric shape. For example, a frame platform may have four members circumscribing a rectangle with an internal defined open space.

The term “base support platform” refers to a structural piece of a device that is attached to a frame platform having the same geometric shape.

The term “plate-support block” refers to a structural piece of a device that is shaped for insertion into an open cavity of a plate skirt such that the top surface of the plate-support block fully contacts the bottom surface of the plate.

The term “restraint flange” refers to a structural piece of a frame platform that provides physical restraint and/or stability to a plate that is secured thereto.

The term “support post” refers to a structural piece between the base support platform and the frame platform by attaching to the top surface of the base support platform and is slidably engaged with the frame platform. The support post is not limited to any particular size, shape or material. In one preferred embodiment, the support post is solid and cylindrical.

The term “compressible attachment” refers to a flexible member placed between the base support platform and the frame platform by attaching between the top surface of the base support platform and the bottom surface of the frame platform. The flexible member has compression/expansion properties to permit the base support platform and the frame platform to move either closer together or further apart in response to the amount of force placed upon the frame platform. For example, the compressible attachment may include, but is not limited to, a spring, a piston, a hydraulic chamber, or a compressed gas chamber.

The term “plate” as used herein, refers to any substrate containing at least one compartment with typical applications in high throughput screening. Alternatively, a plate may have multiple compartments. Without limitation, a plate may be of any size and shape. For example, a plate may comprise a plurality of microwells and be referred to as a microplate. While microwells are usually circular or square in shape, they also may be of any size or shape. A plate may be full-skirted (e.g., hard-shell 96-well PCR plate, low profile, full skirted, thin wall with clear wells (Bio-Rad, Cat no. HSP9601); or semi-skirted (e.g., hard-shell 96-well PCR plate, high profile, thin wall, clear wells (Bio-Rad, Cat no. HSS9601). See, also, slas.org/education/ansi-slas-microplate-standards.

The term “skirt” as used herein, refers to a plate circumferential frame extending from the assay compartment bottom surface thereby defining a circumferential plate bottom edge encompassing an open cavity.

The term “skirt height” as used herein, refers to the distance between the assay compartment bottom surface and the circumferential plate bottom edge. See, FIG. 7A. An exemplary differential between skirt heights is a 0.02 mm skirt height of a Perkin Elmer CellCarrier 384, as compared to a 4.19 mm skirt height of a Beckman Coulter Echo 384 LDV. See, FIG. 7B cf 7C.

The terms “arrays” and “microarrays” are used somewhat interchangeably differing only in general size. The instant invention involves the same methods for making and using either. Each array typically comprises a plurality of well that may contain many cells or wells (typically 100 1,000,000+) wherein each well is at a known location and contains a specific component of interest. Each array therefore may contain numerous different components of interest.

The term, “substrate” is used to describe a surface composition of a solid phase which may comprise an array, a microarray or a device. In some cases, the substrate is solid and may include plastic (for example, polypropylene, polystyrene, cyclic olefin copolymer), glass, quartz and/or polydimethylsiloxane.

### BRIEF DESCRIPTION OF THE FIGURES

FIG. 1 illustrates one embodiment of an adjustable plate support stage device.

FIG. 2 illustrates one embodiment of a conventional microplate having a skirt with a skirt height and open cavity (see inset).

FIG. 3 illustrates one embodiment of an adjustable plate support stage device in a released configuration.

FIG. 4 illustrates one embodiment of an adjustable plate support stage device in a depressed configuration.

FIG. 5 illustrates a PlateLoc® automated microplate sealer instrument (Agilent) compatible with the presently disclosed adjustable plate support stage device.

FIG. 6 compares a visual assessment of microwell seal quality.

FIG. 6A: An example of a high-quality seal.

FIG. 6B: An example of a poor-quality seal.

FIG. 7 illustrates a microplate skirt height and exemplary differences between two commercially available microplates.

FIG. 7A: A diagrammatical representation of a skirt height measurement.

FIG. 7B: A photomicrograph depicting the 0.02 mm skirt height of a Perkin Elmer CellCarrier 384 microplate.

FIG. 7C: A photomicrograph depicting the 4.19 mm skirt height of a Beckman Coulter Echo 384 LDV microplate.

FIG. 8 presents exemplary data showing grip/skirt height variability between a commercially available PlateLoc static stage and the presently disclosed dynamic universal stage.

FIG. 8A: Grip height variability using a variety of commercially available microplates comparing a PlateLoc static stage to the presently disclosed dynamic universal stage.

FIG. 8B: Scatterplot analysis showing the relationship between skirt height and grip height variability.

FIG. 9 presents exemplary data showing stage movement error variability between a commercially available PlateLoc static stage and the presently disclosed dynamic universal stage.

FIG. 9A: Movement failure comparison between a PlateLoc static plate and the dynamic universal plate as disclosed herein.

FIG. 9B: Scatterplot analysis showing the relationship between skirt height and movement error variability.

FIG. 10 presents several embodiments of plate adapters.

FIG. 10A: Photomicrographs comparing a static stage adaptor (left) with a dynamic stage adaptor (right) for use with a Corning Low Volume 384 microplate.

FIG. 10B: Photomicrographs comparing a static stage adaptor (left) with a dynamic stage adaptor (right) for use with a Beckman Coulter Echo 384 PP microplate.

FIG. 11 presents a representative example of a microplate gripper device.

FIG. 11A: An illustration of a gripper device with dimension annotations that are used in determining grip height and microplate compatibility.

FIG. 11B: A photomicrograph of an exemplary gripper device interfacing with a representative microplate annotated with formulas to calculate grip height and the theoretical/actual differential using the parameters shown in FIG. 11A.

FIG. 12 presents exemplary data showing the superior performance of microplate sealing using the presently disclosed dynamic universal plate as compared to a PlateLoc static plate. See, also, Table 2.

### DETAILED DESCRIPTION OF THE INVENTION

The present invention is related to the field of high-throughput laboratory automation and instrumentation. In particular, a dynamic plate support stage device is disclosed which makes any multi-well plate compatible with any commercially available instrument that acts on plates by generating downward vertical force by compensating for plate skirt height variations. For example, when applied in the context of a plate sealer stage, the dynamic support stage device comprises a rectangular upper frame supported by a compressible attachment and surrounds a plate-support block upon which a plate is secured. When in use, a sealer instrument applies downward force on the plate, which depresses the rectangular upper frame around the plate/plate-support block complex until the well bottom fully contacts the plate-support block thereby compensating for any plate skirt height variation. Upon completion of the sealing cycle, the upper frame returns to the upper at rest position providing a universal point in space where all plates start and end the cycle.

In one embodiment, the present invention contemplates an improvement to using commercially available automated microwell array sealers by using a device that adjusts for dimensional differences between different types and or brands of microwell array plates. For example, the device compensates for differential skirt heights between microwell array plates from different manufacturers. In one embodiment, the device is designed with a top rectangular frame platform with an internal opening aligned with a block support plate compressibly attached to a lower base support platform.

In one embodiment, the present invention contemplates a method comprising securing a plate (e.g., a microwell array plate) within at least one restraint flange of a top rectangular frame platform. In one embodiment, the method further comprises depressing the top rectangular frame platform with a conventional microplate sealer, wherein a microwell array plate is supported only on the plate-support block. Although it is not necessary to understand the mechanism of an invention, it is believed that the present device and method permits any microwell array plate, regardless of skirt height, to be properly supported within any automated microplate sealer instrument thereby ensuring full contact between the sealer unit and the microplate top surface without deflecting the microplate to provide a fully attached seal.

### I. Conventional Microplate Sealer Devices

Various devices have been disclosed to seal microplates. For example, an automated microplate lidder/delidder apparatus having a lid press assembly was reported. The lid press assembly and support platform are configured with compressible pistons or springs that move the lid press assembly and/or support platform up and down relative to the microplate and/or microplate lid. However, this device does not contemplate a plate-support block/microplate complex surrounded by a compressible frame. Nichols et al., “Apparatus For Lidding Or Delidding Microplate” US Patent Application Publication No.: US 2011/0293488.

A device characterized by a film strip having at least one internal opening attached to a pocket permitted microarray alignment and application of a sealing cover strip. However, this device does not contemplate a plate-support block/microarray complex surrounded by a compressible frame. McEntee et al., “Automation-Optimized Microarray Package” U.S. Pat. No. 7,112,305.

A sealing device was disclosed having a top plate that removably attaches to a lid of a collection cup that is supported by a spring assembly. The spring assembly presses downward on the top surface of the device such that the device moves towards the collection cup controlled by compression of the spring assembly. However, this device does not contemplate a plate-support block/collection cup complex surrounded by a compressible frame. Baugh et al., “System And Method For Enabling And Disabling A Portable Assay Reader Device” U.S. Pat. No. 8,491,851.

A device was reported for covering a microwell plate through the use of compressive forces. The device is described as an automated plate server that compresses a microwell plate lid on top of a microwell plate by laterally displacing side walls of the plate lid such that side walls engage and latch onto the plate skirt. However, this device does not contemplate a plate-support block/microwell plate complex surrounded by a compressible frame. Hall et al., “Multi-Well Plate Cover And Assembly Adapted For Mechanical Manipulation” U.S. Pat. No. 6,939,516.

One industry standard laboratory automation plate sealer is known as PlateLoc® (Agilent). One problem with all existing automated plate sealers is that the plate supports are not an automation compatible modular part. For years, the solution for sealing plate types having different dimensions in the same plate sealer instrument was to either: i) manually change the support plate between robot runs to one compatible with the different plate types; ii) deploy multiple plate sealer instruments and dedicate each one to specific plate types; and iii) use one plate support for all microplates of different dimension and use sub-optimal parameters that produced the best-possible seal.

One advantage of the presently disclosed invention over the art allows a microplate to make full contact with the plate sealer regardless of microplate skirt height. This compensatory adjustment capability promotes high quality seals with a high efficiency (see, Example I and II). The compressibility of the device frame also permits all microplates to return to the same height after the sealing cycle is complete for automated access. In contrast, a conventional PlateLoc® support stage is static so using a tall plate support in combination with a microplate having a high well bottom results in the microplate sitting lower than a microplate with a low well bottom. This causes problems for robots that are configured to place all plates on the stage support at the same height.

### II. Plate Sealing Technology: Process And Problems

Choosing the correct combination of microplate closure for each type of microplate plays a role in achieving best laboratory practice and avoids unnecessary work further downstream. Microplates are a convenient method for storing, transporting and handling compounds and samples, but they have common problems associated with them. For example, i) evaporation can occur from the wells of the plate which can affect concentration readings; ii) contamination from dust, spores or other atmospheric detritus may occur; iii) spillage whenever microplates are moved; and iv) cross-contamination when using large multi-well plates (e.g. 96- and 384-well plates). For these reasons, as well as others, those in the art understand that plate sealing is an essential step in the workflow.

Conventional microplates closure methods include, but are not limited to, i) reusable closures (e.g., rigid lids, friction seals or cap mats); ii) single-use closures (e.g., thermal seals or adhesive seals). Each of these methods have particular advantages and drawbacks. Rigid lids are normally transparent and may, in fact be optically clear in the visible region allowing spectroscopic measurements to be taken through the lid. Lids are normally made of clear crystal styrene and may have “anti-condensation” rings on the underside. These raised rings interact with the round wells of assay plates to prevent condensate from travelling along the underside of the lid to any adjacent well where it could cause contamination. Condensation is normally a problem in live cell assays, so plates with anti-condensation lids should always be used for this work. In some cases, a black styrene or polypropylene lid may be used, normally where it is desired to protect samples from visible light. Whilst lids have an important role to play and are easily removed by, for example, automated equipment, they do not form a tight anti-evaporation seal and do not seal individual wells. Friction seals, or cap mats as they are sometimes called, form a physical barrier in the top of each well, thereby preventing leakage and evaporation. They are usually made from a soft pliable polymer such as EVA or silicone to allow them to be forced down into the well. They may be pierceable and some are pre-scored to ease the progress of the needle or tip through the cap mat and into the well. Some types act as septa and will re-seal after the tip is withdrawn. They can be re-used several times if suitably decontaminated but are more expensive initially than disposable seals. Thermal seals are, as the name implies, heat-welded onto the upper surface of the plate to form a very strong and often permanent barrier. The plate material must be compatible with heat-sealing as it will melt during the process. In addition, thin raised rims or walls are needed to ensure a tight and complete seal around the well. Thus, heat seals are not suitable for rimless plates. They tend to work best with polypropylene due to its lower melting point but can also work with most polystyrene plates. Aluminum foil is used for storage of samples in plates and various grades are available varying from extremely robust for deep cold-storage to rather thin, easily pierced foil suitable for robotic applications. One difficulty with thermal seals is that even those designed to be “Peelable” require considerable force to remove them. Re-sealing over the top of the foil is not possible either, it must first be removed entirely. Clear thermal film is used on assay plates to prevent evaporation whilst allowing reading on a microplate reader.

During various assay steps, microplates can be sealed, covered with a lid, or left uncovered. Microplate covers are generally made of clear polystyrene, while plate seals are typically made of aluminum or polyolefin acrylates. A special lid used on GNF robotic systems is designed from a solid block of stainless steel and fitted with an autoclavable sealing rubber gasket designed to increase the plate contact area with the weight of the steel lid ensuring even contact across the plate edges. Michael et al., “A robotic platform for quantitative high-throughput screening” Assay Drug Dev Technol. 2008; 6(5):637-657. These lids add considerably weight to the plate which can cause issues with robot movements and lid removal devices; for these reasons, light weight alternatives are sometimes preferred.

Seals can be generated by an adhesive (e.g., silicone), or by heat (e.g., Agilent PlateLoc). Usual advantages of microplate covers are the prevention of evaporative losses, well-to-well contamination (via spillage or wicking), and biological and environmental contamination. Disadvantages of using seals/lids include additional costs and the procedural steps to accommodate their placement and removal. Therefore, the use of lids or seals for microplates must consider multiple factors:

Length of incubation time. If assays are performed in a short timescale (minutes to several hours), microplate covers might be superfluous as there would be minimal evaporation.

Reaction volume. When using lids or seals, generally avoid filling microplate wells with greater than 50% of the well volume, which mitigates contact between the well contents and the lid.

Condensation. The well contents may condense at the top of lids or seals, which can affect assay performance and even facilitate well-to-well contamination. A brief centrifugation can usually recover condensates from lids or seals prior to their removal. For certain applications, such as live-cell imaging where lids are used, condensation can interfere with image acquisition. This can be mitigated with humidified incubators within the instrument combined with a short (30-60 min) equilibration period prior to imaging.

Number and timing of assay steps. If using lids or seals, carefully consider the timing of the placement and removal steps. For biochemical assays, it might only be necessary to cover microplates after the initiation of the biological reaction, whereas for cell-based assays it is generally recommended to cover microplates whenever there is not active dispensing.

Compatibility with automation and instrumentation. Certain instruments might be able to remove and replace microplate lids. This is generally a manual process for microplate seals. See, azenta.com/products/automated-plate-seal-remover-formerly-xpeel.

Detection. For certain bottom-reading applications, the presence of lids or seals might not interfere with the readout detection (e.g., fluorescence imaging), whereas it may interfere with other applications that require light transmission between the top and bottom of the microplate (e.g., phase-contrast microscopy).

Sealants. Microplate sealants have the potential to chemically modulate bioactivity or interfere with light-based readouts.

Continuous versus end-point assay formats. Continuous or kinetic assays with multiple detection steps might necessitate the repeated removal and addition of microplate covers, especially if multiple plates are being analyzed in a given experiment. To prevent this logistical burden, consider bottom-read options.

Prevention of biological contamination. Depending on the assay, biological contamination might not be a major concern, such as simple biochemical assays. However, for cell-based assays, covering microplates is practically essential.

Prevention of environmental contamination. Environmental contamination from airborne particulates (dust) might be a concern for certain light-based readouts.

Permeability. Certain materials designed for either gas or water permeability, while other seals might prevent adequate gas exchange between the incubator and the microplate wells, which can modulate cell functions by perturbing media pH and oxygen content.

Lid stability. Note that certain lid designs might not be as secure as others and therefore might be inadvertently opened (i.e., important for sterility) if not handled with care.

Photo protection. For light-sensitive applications (such as labile fluorophores or AlphaScreen), seals or opaque lids can be used to protect the well contents from light in addition to the usual light-reduction strategies.

Common plate sealing materials include, but are limited to, aluminum, mylar, silicon, polyester, polyolefin, polypropylene, and rayon. Most adhesive seals are acrylate. Seals have certain features that make them appropriate for certain applications, such as peelable, gas permeable, optically clear, solvent resistant, permanent, and pierceable, among others. Exemplary types of seal material are; i) Axygen® (Platemax Aluminum Sealing Films, Cat no. PCR-AS-600); and ii) MicroAmp Clear Adhesive Film (Plastic Thermo Fisher Scientific, Cat No: 4306311).

The choice of microplate polymer can impact assay quality due to properties such as light transmission, autofluorescence, water absorption, and gas exchange. Light absorption by a polymer decreases sensitivity in fluorescence assays by attenuating the intensity of the excitation illumination, while autofluorescence from a polymer can decrease sensitivity and dynamic range by contributing additional light to the assay emission signal. The common polymer, Polystyrene (PS) is generally not suitable for transmitting UV light, while Cyclic Olefin Copolymer/Cyclic Olefin Polymer (COC/COP) are often used for such purposes. The autofluorescence from a microplate can also vary depending on the plate material and will also vary based on the pigments used in generating the color.

Polymers can also have different propensities to absorb water and exchange gases. Niles et al., “Cyclic olefin polymers: Innovative materials for high-density multi-well plates” Assay Drug Dev Technol. 2008; 6(4):577-590. Finally, polymers have different mechanical and thermal properties. The mechanical properties are important considerations during the manufacturing process, but more relevant for end-users, day-to-day handling where overly brittle or flexible polymers can crack or warp with aggressive handling, respectively. Thermal properties can play a role when sealing plates with heat sealers, as excessive or prolonged heating can result in warping of the plate (small degrees of bending or torsion can cause significant perturbations) and also issues with imaging or handling of the plates by automated robot systems.

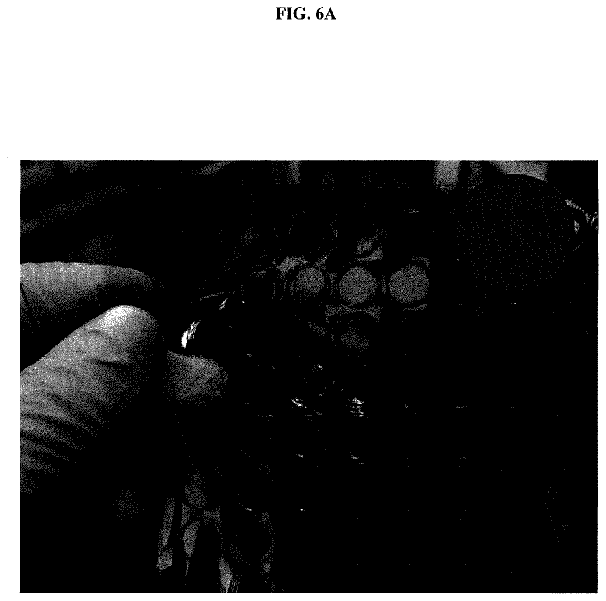

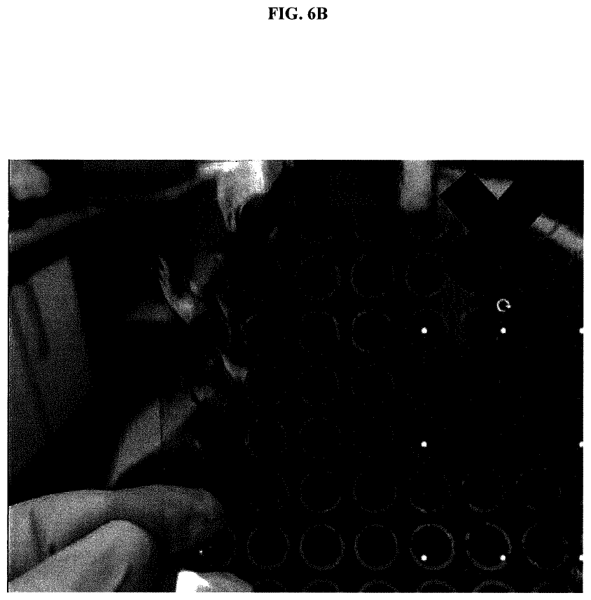

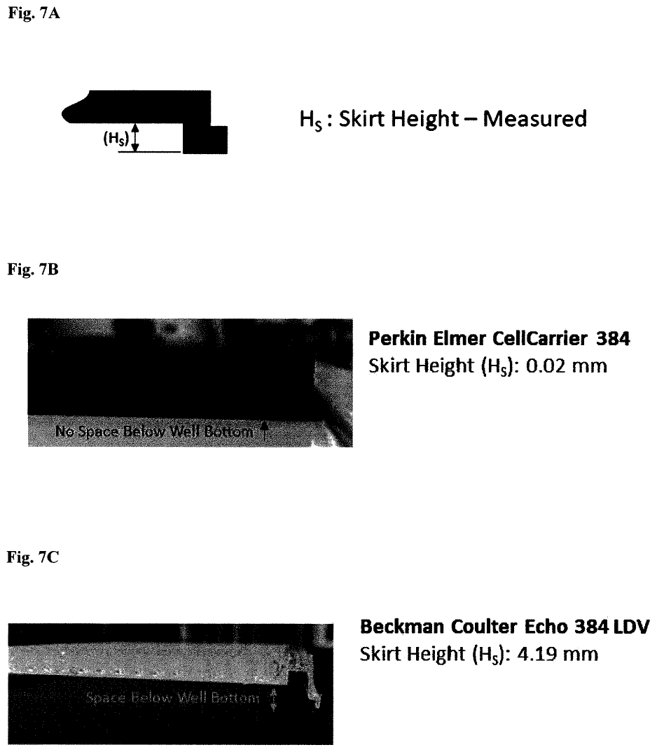

Seal quality depends on a number of factors including, but not limited to, microplate material, microplate design, seal material, microplate stability, seal temperature and/or seal-cycle duration. A high-quality seal will have distinct indentations in the seal material and no gaps in seal around the wells. See, FIG. 6A. In contrast, a low-quality seal will have minimal surface adhesion with visible gaps in seal around well. See, FIG. 6B.

### III. Dynamic Universal Plate Support Stage Device

Sealing a microplate properly requires full contact between the microplate top and the sealing unit of an automated microplate sealer instrument (e.g., a PlateLoc® device, Agilent). Although it is not necessary to understand the mechanism of an invention, it is believed that such full contact results in a high quality and efficient sealing process that supports high throughput processing by increasing both quality and productivity. Although those in the art have standardized microplates in terms of width and length, the skirt height of different plate types varies. The variation of plate skirt height presents a challenge to the industry when using standard laboratory automation plate sealers. The most common solution was to manually change the support stage to accommodate different plate types during an automation process. As disclosed herein, a universal plate stage has been designed to accommodate microplates with various skirt height used in automated screening system and solves the present problem.

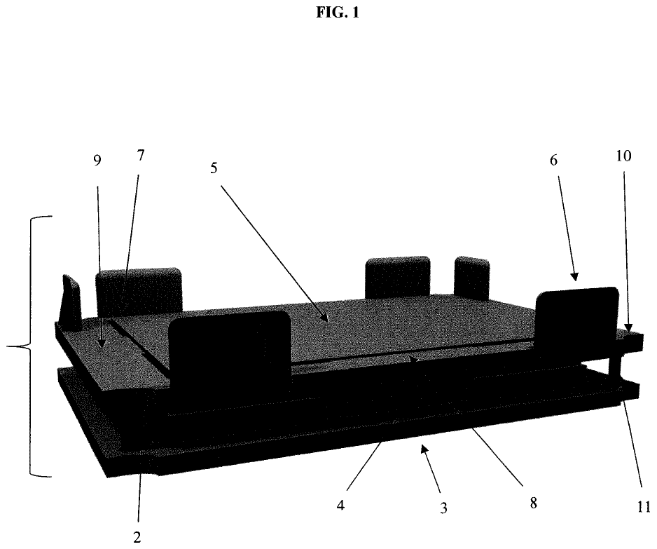

In one embodiment, the presently disclosed adjustable microplate support stage device (1) comprises a rectangular frame (2) and a base support platform (3) attached together at the corners and held apart by at least one compressible attachment (4). A plate block (5) (e.g., a metal block with a rubber coating) is centrally located relative to the rectangular frame and the base support platform. In one embodiment, the rectangular frame further comprises at least one restraint flange (6). In one embodiment, the rectangular frame further comprises a first member (7), a second member (8), a third member (9) and a fourth member (10). In one embodiment, the device further comprises at least one post (11) that slidably engages the rectangular frame with the base support platform. See FIG. 1.

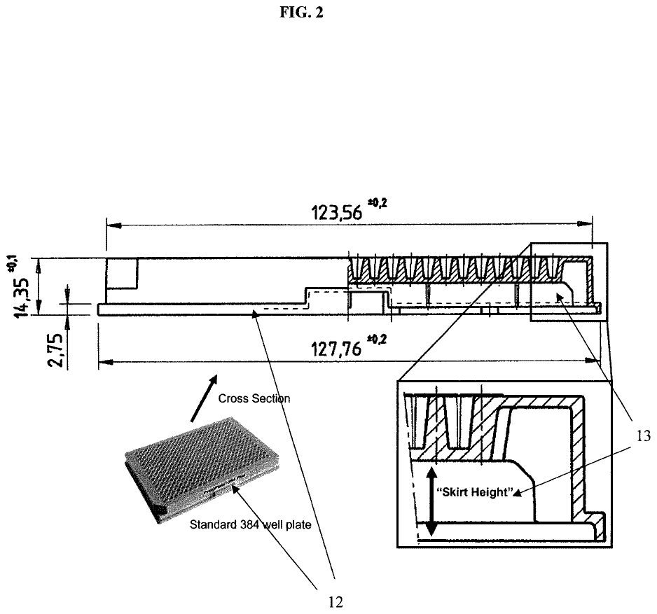

In one embodiment, the present invention contemplates a method providing an adjustable microplate support stage device comprising a rectangular frame and a plate block, a microplate and a conventional microplate sealer instrument. In one embodiment, the method further comprises applying a thin seal to the top of the microplate by the microplate sealer instrument. In one embodiment, the microplate is a multi-well microplate. In one embodiment, the microplate comprises a skirt (12) having a height. In one embodiment, the skirt height ranges from less than a millimeter up to about 8 millimeters. See, FIG. 2.

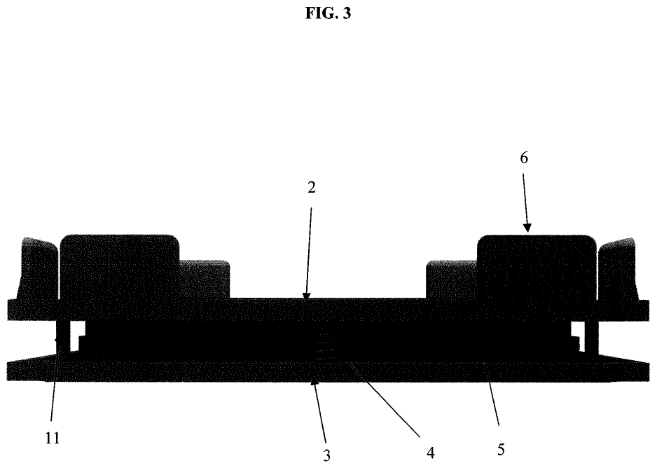

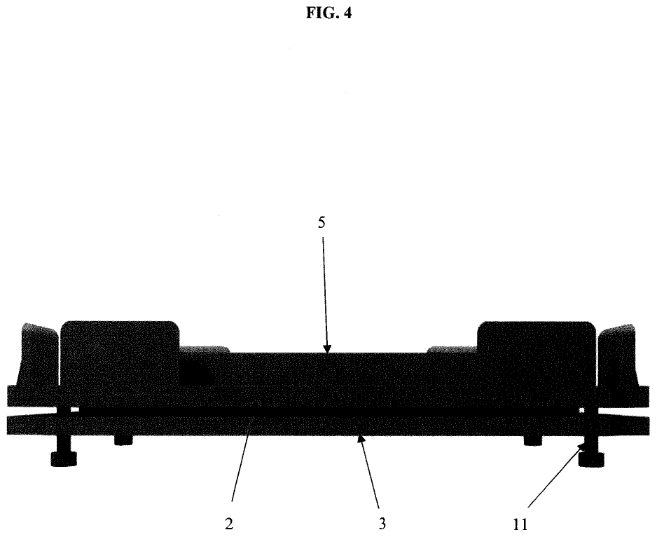

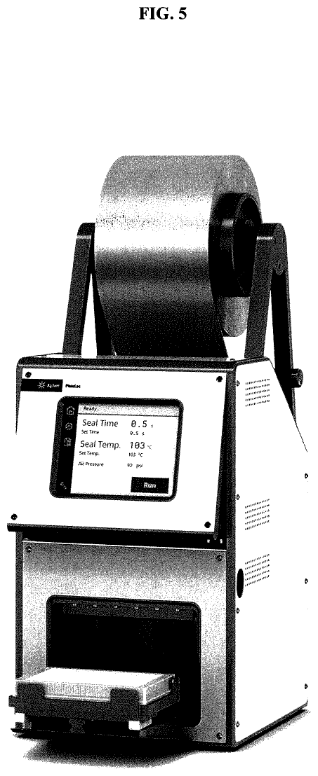

In one embodiment, the method further comprises depressing the rectangular frame (2) with the microplate sealer instrument. In one embodiment, the depressing further comprises inserting the plate block (5) into the skirt open cavity (13) until the microplate well bottoms are in full contact with the plate block. In one embodiment, the depressing comprises at least one compressible attachment (4). In one embodiment, the support block holds the plate at a constant height whether the dynamic plate support stage is in a released state (See, FIG. 3) or a depressed state (See, FIG. 4). In one embodiment, the method further comprises contacting the plate with a sealing unit of an automated plate sealer (e.g., PlateLoc®, Agilent). See, FIG. 5.

Skirt height compatibility with the dynamic plate sealer device was evaluated using a variety of commercially available microplates. See, Table 1.

TABLE 1
Skirt Heights of Commercially Available Microplates

| | Skirt | Universal | Static |
|---|---|---|---|
| | Height | Delta | Delta |
| Plate | (mm) | Gr. Ht. | Gr. Ht. |
| Perkin Elmer ProxyPlate 384 | 7.69 | 0.55 | 5.84 |
| Perkin Elmer CulturePlate 384 | 2.59 | 0.47 | 3.89 |
| Corning Round Bottom 384 | 1.84 | 0.28 | 3.76 |
| Beckman Coulter Echo 384 LDV | 4.19 | 0.25 | 5.81 |
| Beckman Coulter Echo 1536 LDV | 4.29 | 0.3 | 5.85 |
| Beckman Coulter Echo 384 PP | 2.27 | 0.14 | 4.86 |
| Perkin Elmer CellCarrier 1536 | 0.29 | 0.51 | 3.24 |
| Perkin Elmer CellCarrier 384 | 0.02 | 0.45 | 2.97 |
| Corning Low Volume 384 | 1.91 | 0.2 | 4.51 |
| Corning LV Imaging 384 | 0.23 | 0.31 | 3.09 |
| Perkin Elmer CellCarrier 96 | 0.31 | 0.37 | 3 |
| Greiner Imaging 1536 | 0.23 | 0.39 | 3.21 |
| Perkin Elmer CulturePlate 1536 | 6.84 | 0.15 | 5.62 |

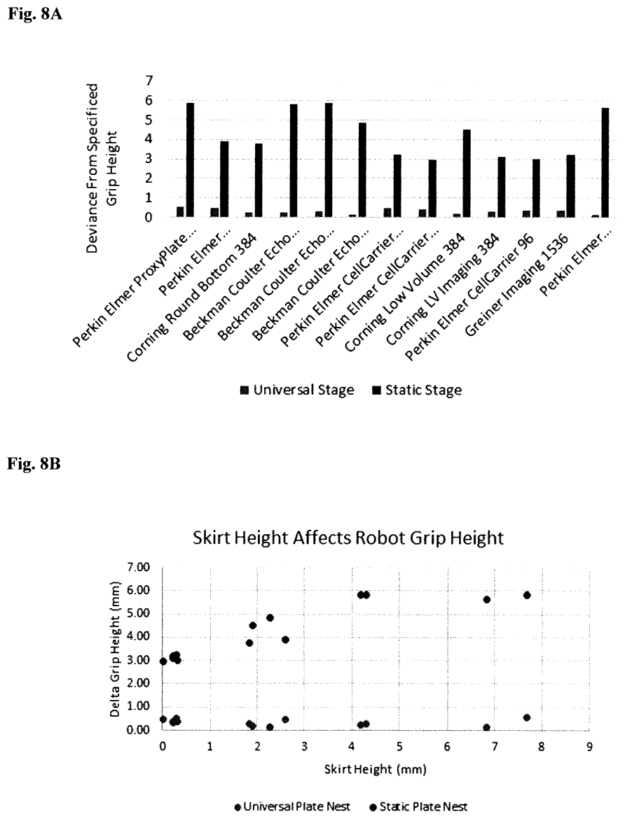

These commercially available plates were used to compare a PlateLoc static stage with the presently disclosed dynamic universal plate to determine the relationships between grip height and skirt height using a standard microplate gripper device. The data shows that the PlateLoc static stage demonstrated a grip height deviation ranging between three (3)-six (6) millimeters as compared to a grip height deviation of less than 0.5 mm with the dynamic universal plate. See, FIGS. 8A and 8B.

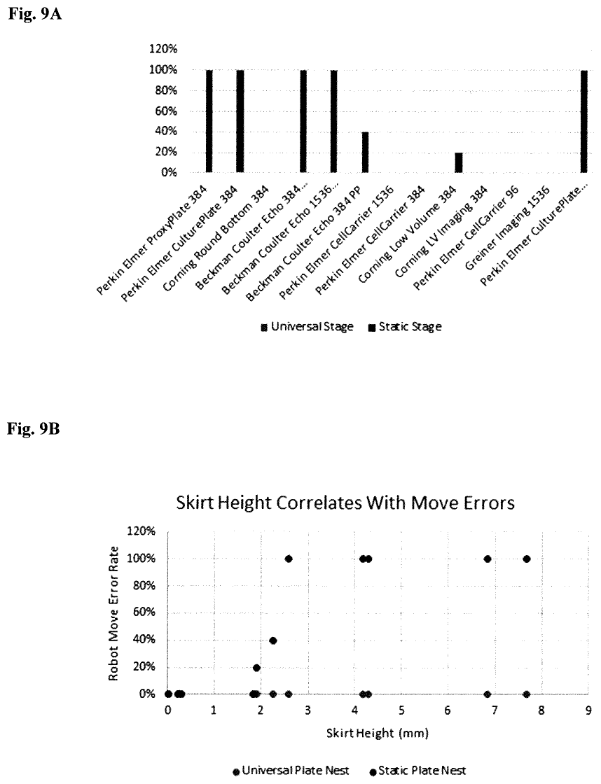

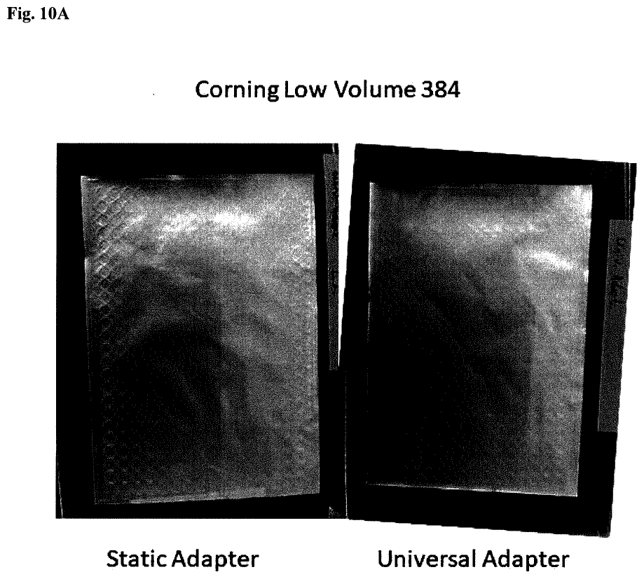

The rate of stage movement failure was also compared. The data shows that the PlateLoc static plate encountered movement failures forty-three percent (43%) of the time as compared to the dynamic universal plate which encountered zero percent (0%) movement failures. See, FIGS. 9A and 9B.

### EXPERIMENTAL

### Example I

### Sealing Efficiency

This example provides a side-by-side comparative test of sealing efficiency between a conventional plate support device and the presently disclosed dynamic plate support device.

A diversity of plates has been sealed with a PlateLoc® sealing instrument after being secured in either a conventional plate support device or an adjustable plate support device. The data shows that plates sealed with a conventional plate support device have a higher percentage of seal imperfections than plates sealed with adynamic plate support device.

### Example II

### Sealing Quality

This example provides a side-by-side comparative test of sealing quality between a conventional plate support device and the presently disclosed adjustable plate support device.

An equal number of microplates will be filled with a hygroscopic solvent, DMSO, and sealed with a PlateLoc® sealing instrument after being secured in either a conventional plate support device or a dynamic plate support device. The fluid composition is measured with an Echo 655T acoustic liquid handler (Beckman Coulter). The sealed microplates are then stored for twenty-one days. Following the storage period, the fluid composition is measured again, and the difference calculated.

The data shows that plates sealed with a conventional plate support device have a similar fluid composition to plates sealed with an adjustable plate support device after storage.

### Example III

### Automation Compatibility

This example provides a side-by-side comparative test of robot compatibility between a conventional plate support device and the presently disclosed dynamic plate support device.

An equal number of microplates will be moved to and from a PlateLoc® sealing instrument fitted with either a conventional plate support device or a dynamic plate support device. The rate of robot move failures was calculated by counting the number of failed moves out of a total of ten trials.

The data shows that plates with a skirt height of about 2 mm or greater fail every move away from the conventional plate support device whereas moves away from the dynamic plate support device succeed every trial.

### Example IV

### 3D Model Design and Printing

Computer Aided Design (CAD) files were generated using TinkerCad (Autodesk), a web-based CAD software. Designs were exported in STL format and loaded to PrusaSlicer (Prusa) for preparation for printing. Object models were sliced, and the print path was saved in gcode format. Printer specific gcode files were transferred to a Prusa Mk3s 3D printer fitted with a MMU2 multi-material unit (Prusa) for production. All models were printed with Prusament PLA filament (Prusa) producing PLA plastic objects.

The dynamic universal plate stage was designed to be printed in multiple pieces and assembled using commercial screws and springs (McMaster-Carr) and a rubber topped aluminum plate support (Beckman Coulter).

Prototype plate stages were assembled by aligning the springs into the cutouts on the frames. Screws were used to retain the frames in alignment and were inserted once the springs were in place. The plate support was added to the plate stage holder last.

### Example V

### Universal Plate Stage Installation

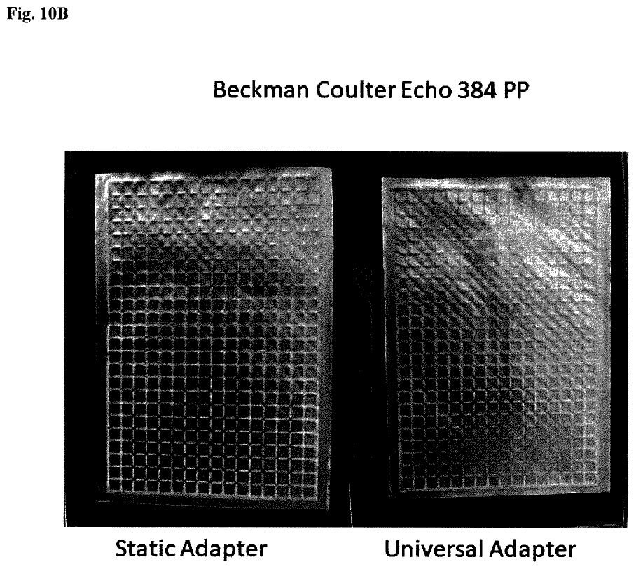

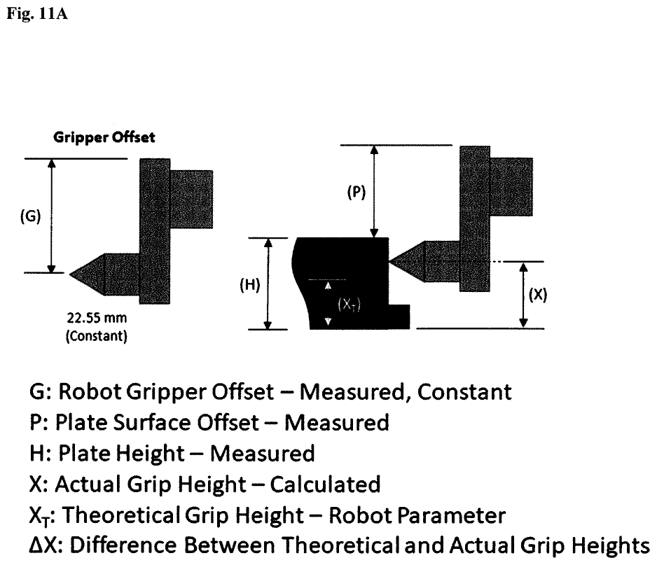

An exemplary universal plate sealer stage prototype, as described herein, was designed to be compatible with a PlateLoc (Agilent Technologies) plate sealer. To install the prototype, the plate sealer stage was removed. Next, the plate adapter was removed from the stage. See, FIGS. 10A & 10B. The stage attachment screws were then also removed. The stage was then lifted off the stage slide mechanism. The universal plate sealer stage is directly compatible with the PlateLoc stage slide mechanism. The universal plate sealer stage possesses holes that align with the screw hole pattern on the stage slide mechanism. The PlateLoc stage attachment screws were reused to attach the universal adapter. The plate adapter can be reused with the universal stage if desired.

### Example V1

### Robot Reliability Testing

A variety of plates were moved into and out of the universal plate stage using an ACell robot arm (HighRes Biosolutions) controlled by Cellario (HighRes Biosolutions). Each plate type was placed onto and picked off of either the universal plate stage or the static plate stage ten (10) times and returned to a fixed position between each test cycle. The number of robot errors encountered in each test was recorded for each plate type. The rate of failure was calculated for each plate in each plate stage.

### Example VII

### Robot Grip Height Calculation

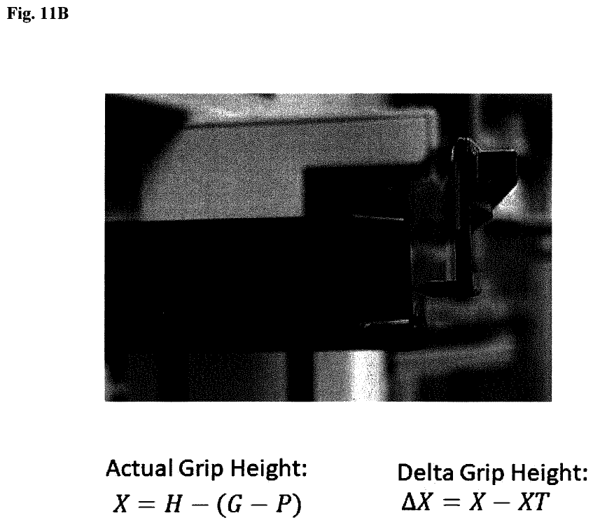

A variety of plate types were picked off of either the static stage or universal plate stage by a standard plate gripper device. See, FIG. 11A. With the plate held in the gripper, the distance from the top of the gripper fingers to the top of the plate was measured. This distance was used to calculate the grip height using Formula 1 and the difference between the theoretical grip height and the actual grip height was calculated using Formula 2. See, FIG. 11B.

### Example VIII

### Sealing Performance Testing

Using a PlateLoc fitted with Peelable Aluminum RT plate seals (Agilent Technologies), and a universal plate stage prototype, plates with a variety of geometries were sealed using sealing time and temperature settings appropriate for each plate. The same PlateLoc was refitted with the stock plate stage and the same plates were sealed using the same time and temperature parameters. Sealed plates were allowed to cool to ambient temperature and the seal was peeled off and photographed to examine the quality of the seal. Each well that was imperfectly sealed was counted and number of imperfections was recorded for each plate and plate stage combination.

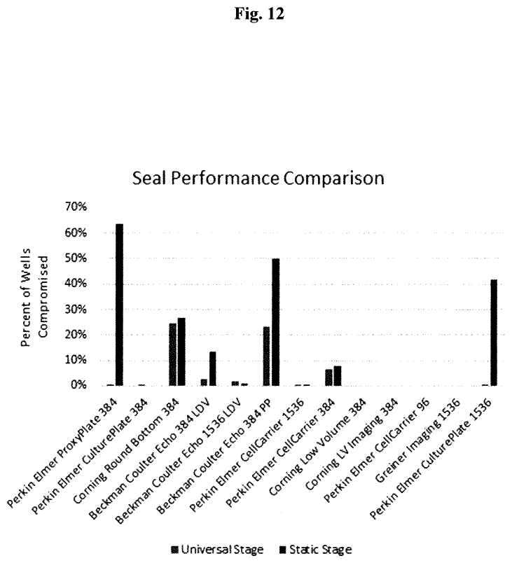

The data show that by comparing a variety of commercially available microplates the static PlateLoc stage resulted in compromised seals 15.7% of the time, as compared to the universal dynamic stage which encountered a compromised seal only 4.7% of the time. See, Table 2 and FIG. 12.

TABLE 2
Seal Failure Rates Between A Standard Static Stage And A Dynamic Stage

| | | Universal Stage | | Static Stage | |
|---|---|---|---|---|---|
| | | | Percent | | Percent |
| Plate | Wells | Compromised | Compromised | Compromised | Compromised |
| Perkin Elmer ProxyPlate 384 | 384 | 2 | 0.521% | 244 | 63.542% |
| Perkin Elmer CulturePlate 384 | 384 | 3 | 0.781% | 0 | 0.000% |
| Corning Round Bottom 384 | 384 | 95 | 24.740% | 103 | 26.823% |
| Beckman Coulter Echo 384 LDV | 384 | 11 | 2.865% | 51 | 13.281% |
| Beckman Coulter Echo 1536 LDV | 1536 | 26 | 1.693% | 13 | 0.846% |
| Beckman Coulter Echo 384 PP | 384 | 90 | 23.438% | 191 | 49.740% |
| Perkin Elmer CellCarrier 1536 | 1536 | 2 | 0.130% | 6 | 0.391% |
| Perkin Elmer CellCarrier 384 | 384 | 25 | 6.510% | 31 | 8.073% |
| Corning Low Volume 384 | 384 | 0 | 0.000% | 0 | 0.000% |
| Corning LV Imaging 384 | 384 | 0 | 0.000% | 0 | 0.000% |
| Perkin Elmer CellCarrier 96 | 96 | 0 | 0.000% | 0 | 0.000% |
| Greiner Imaging 1536 | 1536 | 0 | 0.000% | 0 | 0.000% |
| Perkin Elmer CulturePlate 1536 | 1536 | 4 | 0.260% | 640 | 41.667% |

We claim:

1. A dynamic plate support device, comprising:
a) a rectangular frame platform comprising a length and a width, said rectangular frame platform defined by:
i) a first member comprising a first top surface and a first inner surface, wherein said first top surface is shorter than said length and longer than said width;
ii) a second member comprising a second top surface and a second inner surface, wherein said second top surface is shorter than said length and longer than said width;
iii) a third member comprising a third top surface and a third inner surface, wherein said third top surface is shorter than said width; and
iv) a fourth member comprising a fourth top surface and a fourth inner surface, wherein said fourth top surface is shorter than said width;
b) a base support platform comprising said length and said width, wherein said base support platform comprises at least one compressible attachment that interfaces with a bottom surface of said rectangular frame platform; and
c) a plate-support block attached to a top surface of said base support platform that is positioned below, and aligned within, said first inner surface, said second inner surface, said third inner surface and said fourth inner surface.

2. The device of claim 1, wherein said rectangular frame platform further comprises at least one restraint flange.

3. The device of claim 1, wherein said device further comprises at least one support post attached to said rectangular frame platform and slidably engaged with said base support platform.

4. The device of claim 1, wherein said at least one compressible attachment comprises a spring.

5. The device of claim 1, wherein said at least one compressible attachment comprises a piston.

6. The device of claim 1, wherein said at least one compressible attachment comprises a hydraulic chamber.

7. The device of claim 1, wherein said at least one compressible attachment comprises a compressed gas chamber.

8. The device of claim 2, wherein said device further comprises a plate secured by said at least one restraint flange.

9. The device of claim 8, wherein said plate further comprises a skirt having an open cavity.

10. The device of claim 8, wherein said plate is a microplate.

11. The device of claim 10, wherein said microplate comprises an array of microwells.

12. The device of claim 9, wherein said skirt comprises a skirt height ranging between 0-8 millimeters.

13. The device of claim 1, wherein said first inner edge, said second inner edge, said third inner edge and said fourth inner edge define an internal opening within said rectangular frame platform.

14. A method, comprising:
a) providing;
i) a dynamic plate support stage device comprising a plate block surrounded by a rectangular frame;
ii) a plate comprising a skirt with an open cavity and an assay compartment bottom surface; and
iii) a plate sealer instrument;
b) securing said plate within said rectangular frame; and
c) inserting said plate-support block into said skirt open cavity.

15. The method of claim 14, wherein said inserting further comprises fully contacting said plate-support block with said assay compartment bottom surface.

16. The method of claim 14, wherein said inserting further comprises depressing said rectangular frame with said plate sealer instrument.

17. The method of claim 14, wherein said plate sealer instrument comprises a sealer unit.

18. The method of claim 16, wherein said method further comprises sealing the top of said plate with said sealer unit.

19. The method of claim 14, wherein said rectangular frame platform comprises an internal opening defined by a first inner edge, a second inner edge, a third inner edge and a fourth inner edge.

20. The method of claim 19, wherein said depressing further comprises lowering said internal opening around said plate block.

21. The method of claim 14, wherein said dynamic plate support stage device further comprises at least one support post attached to said rectangular frame platform and is slidably engaged with said base support platform.

22. The method of claim 14, wherein said dynamic plate support stage further comprises at least one compressible attachment that interfaces with the base support platform and the bottom surface of the rectangular frame.

23. The method of claim 22, wherein said at least one compressible attachment is selected from the group consisting of a spring, a piston, a hydraulic chamber and a compressed air chamber.

24. The method of claim 14, wherein said securing further comprises at least one restraint flange attached to said rectangular frame.
